(19) United States
(12) Patent Application Publication
(10) Pub. No.: US 2009/0021816 A1
(43) Pub. Date: Jan. 22, 2009

(54) APPARATUS AND METHOD FOR LASER AND OPTICAL COUPLING

(76) Inventors: Xin Simon Luo, Monterey Park, CA (US); Pei Chuang Chen, La Canada Flintridge, CA (US); Leming Wang, Arcadia, CA (US); Zhijie Wang, Arcadia, CA (US)

Correspondence Address: Nixon Peabody, 200 Page Mill Road, Suite 200, Palo Alto, CA, 94306, US

(21) Appl. No.: 11/853,815

(22) Filed: Sep. 12, 2007

Related U.S. Application Data
(60) Provisional application No. 60/827,066, filed on Sep. 27, 2006.

(51) Int. Cl. G02B 26/08

(52) U.S. Cl. 359/196

(57) ABSTRACT

An apparatus and method steer a light through a lens into a receiving port via a steering device. The steering device is located between the lens and a light source. A feedback mechanism adjusts the steering device to correct for aberration.

### PRIORITY REFERENCE TO PRIOR APPLICATIONS

This application claims benefit of and incorporates by reference U.S. patent application Ser. No. 60/827,066, entitled “System, Method and Apparatus for Laser and Optical Coupling,” filed on Sep. 27, 2006, by inventors Xin Luo et al.

### TECHNICAL FIELD

This invention relates generally to laser and optical coupling and more particularly provides an apparatus and method for coupling multiple light sources (e.g. lasers) to a receiving device (e.g., port, fiber optic cable).

### BACKGROUND

In WDM (wavelength division multiplexed) communications, many wavelengths are transmitted over an optical fiber simultaneously to make use of the high bandwidth capability of the low loss optical fiber. Multiple laser sources at different wavelengths coupled into a single optical fiber are often used as a wavelength tunable lasing device that covers a wide WDM spectrum range. Wavelength tuning is achieved by selecting the right lasing source (coarse tuning), and by fine tuning the lasing wavelength of the selected source through temperature and/or current.

A compact form of such a multi-source device can be built using a laser array and coupling optics. One or more movable elements in the coupling optics can be used to selectively couple light output from any one of the many lasers from the array. In such a device, it is important for light from each laser of the array to be coupled in a consistent, stable and low loss, fashion. If the light beam of any laser in the array deviates from the optical axis of the coupling optics, aberration can occur. Furthermore, the location of the movable optical element(s) can significantly affect the degree of aberration experienced by the light beam. This aberration has the effect of causing coupling loss, system instability and poor device reliability.

Accordingly, a new apparatus and method are needed to prevent or correct for aberration.

### SUMMARY

The method and apparatus described herein provide one or more light sources, and integration and/or assembly with optical components to host a selected one of the one or more light beams of various wavelengths to an output device. One or more movable components that can be controlled are used to steer the selected light beam. It is well known that light beams that travel off the system optical axis can suffer from aberration effects. Steering the beam near the sources before the optical components that cause aberration serves to minimize such aberrations experienced by off-axis light beams. The parameters of the one or more various components are adjustable to optimize the optical coupling efficiency for one or more selectable light sources.

In an embodiment, an apparatus comprises a light source; a steering device; a lens; and a feedback mechanism communicatively coupled to the steering device. The steering device is located between the light source and the coupling lens. The feedback mechanism determines optical properties such as aberration, optical power and power distribution after the light traverses the lens and adjusts the steering device to correct for changes.

In an embodiment, a method comprises: generating a light from a light source; steering the generating light via a steering device through a lens; determining optical properties such as aberration, optical power and power distribution after the light traverses the lens; and correcting for changes in the light by adjusting the steering device; wherein the steering device is located between the light source and the optical lens.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a front active optical steering apparatus; and

FIG. 2 is a flowchart illustrating a method of steering an optical beam.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

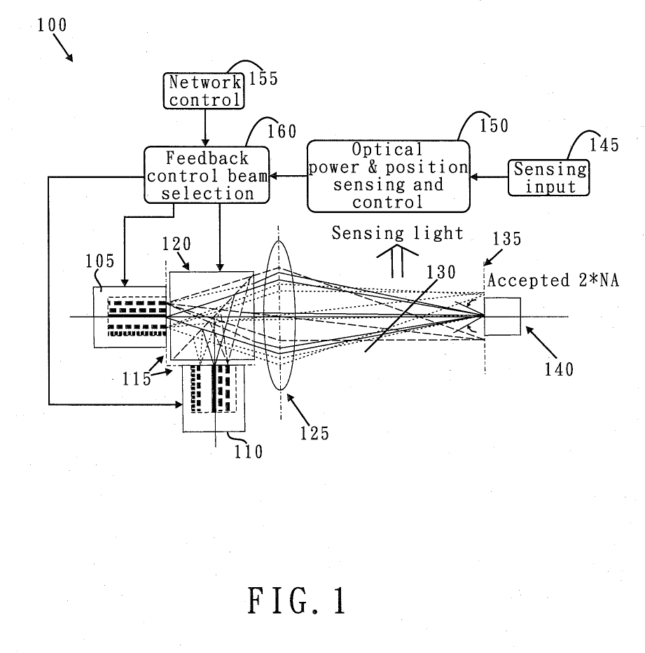

FIG. 1 is a block diagram illustrating a front active optical steering apparatus 100 according to an embodiment of the invention. The apparatus 100 includes one or more light source arrays 105 and 110 that emit light into an active optical steering device 120. The steering device 120 steers light through a lens 125 into an optical device receiving port 140. In addition, a beam splitter 130 is located between the lens 125 and the port 140 and splits off some light to a sensing input 145. The sensing input 145 feeds sensing data to an optical power & position sensing and control module 150, which feeds data to a feedback control and beam selection module 160 (which is also coupled to a network control module 155). The module 150 determines the current position of the steering device 120 while the module 160 adjusts the steering device 120 based on data from the sensing input 145 and the current positioning of the steering device 120 (determined by the module 150), thereby correcting for aberration. The module 160 also enables the selection of one or more stripes in an embodiment in which the light sources 105 and 110 include laser arrays. The module 160 also enables the selection of one of the plurality of light sources 105, 110.

As embodiments of the invention place the beam steering optical device 120 between the light sources 105 and 110 and the lens 125, this apparatus 100 is more efficient at selecting different light sources, and can cover a broader lateral spread of the light sources compared to having the steering device 120 located after the lens 125. Furthermore, by adjusting the degree of beam steering in, aberration of the entire apparatus 100 can be significantly reduced or minimized, resulting in superior stability and coupling efficiency.

In an embodiment the steering device 120 includes a Microelectromechanical system (MEMS) mirror placed in front of the array laser 105 and/or 110; light beam from one or more stripes of the laser array 105 and/or 110 is guided by the mirror 120 into the lens 125, which then focuses the light into an optical fiber (e.g., at port 140). The lens 125 includes a converging or ball lens. By moving and/or rotating this mirror, light beams from lasers that are not collinear with the optical axis of the lens can be brought closer to the optical axis. Proper adjustment in the steering angle in both axes leads to lower aberration. In other embodiments, the beam steering device 120 includes acousto-optic and/or electro-optic modulators.

The light source 105 or 110 can be an array of lasers on a single chip. Each laser in the array is individually addressable. The lasers may incorporate internal gratings such as those in distributed feedback (DFB) or distributed Bragg reflector (DBR) lasers to ensure single longitudinal mode operation. In an embodiment each laser's Bragg wavelength is spaced a few nm (e.g. about 2 to about 5 nm) apart to afford a wide spectral coverage. Temperature tuning can be used to change the Bragg wavelength of each individual element of the array.

In an embodiment, the light sources 105 and/or 110 include an edge emitting laser chip that operates at speeds of 10 Gbps or higher. Further, the light sources 105 and/or 110 have a wavelength of 1310 nm or 1550 nm. In an embodiment, the light sources 105 and/or 110 include a Fabrey-Perot (FP) laser.

In an embodiment, the stripes of the laser array are manufactured so each laser emission is in a slightly different direction to assist in the aberration correction. The emission direction can result from tilting the laser stripes with respect to the front facet of the laser array chip. Degree of tilt can be designed to match the focusing characteristics of the lens.

In an embodiment, the light source 105 emits light straight to the lens 125 while the light source 110 emits light perpendicular (or otherwise at any angle) to the lens 125. The steering device 120 then adjusts the perpendicular light to traverse the lens 125. In other words, an objective plane 115 of the light source 105 faces the lens 125 while an objective plane 115 of the light source 110 is perpendicular to the lens 125. In an embodiment, an objective plane 135 of the port 140 can be substantially parallel with the objective plane 115 of the light source 105.

In an embodiment, a beam-steering device 120 is a mirror made using MEMS technology, although other devices like acousto-optic or electro-optic can be used in other embodiments. In an embodiment the device 120 is mounted on the same semiconductor substrate as one or more of the light sources 105, 110.

In an embodiment, through the use of multiple optical components, like lenses, mirrors, and steering device such as MEMS mirror, acoustooptic devices, etc., the apparatus 100 selectively couples multiple light beams into the port 140. One application is in tunable lasers, where an array of lasers, each emitting at a different wavelength, is used as the light sources. Depending on the requested wavelength, a laser stripe is chosen to be biased to emit light. The light emission is refractively and/or reflectively steered to enter a series of optical coupling optics, and then into the port 140.

In an embodiment, the port 140 is coupled to an optical fiber. In other embodiments, other output devices can be coupled to the port 140. Modulators can be used to add signals in the light beam. Therefore, the optical beam is fed into a modulator, such as a LiNb03 (Lithium Niobate) Mach-Zender waveguide or a electroabsorption modulator (EAM). The modulator output is then further optically coupled into an optical fiber.

In an embodiment, some light is tapped from the optical path and fed into appropriate optical elements such as one or more photodectors, beamsplitters, and wavelength lockers. Electrical output from the photodetectors are used to adjust and control operating conditions of the apparatus 100. These include the operating temperature (through the use of a thermal electric cooler), position of the steering device, bias current and output power of the selected light source 105, 110. The nominal positions of the steering device is pre-set at manufacture to select each laser light source. Exact positions of the steering device is controlled by adjustments that optimizes measurable quantities such as received power in the one or more photodetectors.

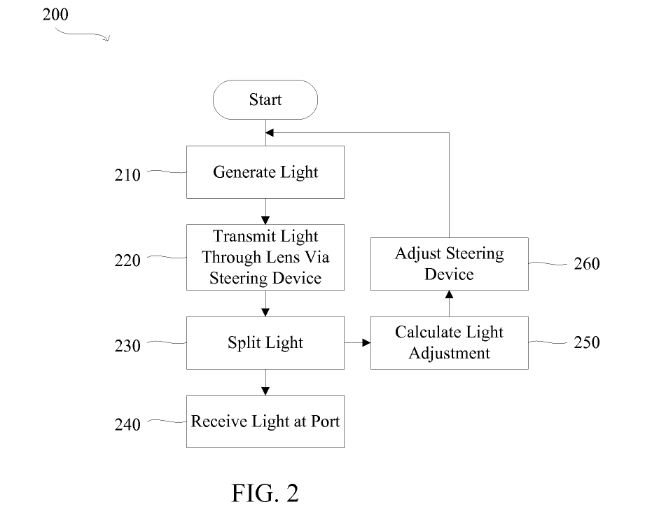

FIG. 2 is a flowchart illustrating a method 200 of steering an optical beam. First, light is generated (210) from one or more light sources. The light is then transmitted (220) through a lens via a steering device located between the lens the light source. A portion of the transmitted light is split (230) off with the remaining light received (240) at a port. An adjustment for steering is then calculated (250) based on the split off light and the steering device is adjusted (260) accordingly. The method 200 then returns to generating (210) and repeats. The method 200 terminates when light is no longer generated.

In an embodiment, the method 200 also includes adjusting the operating temperature of the light source. In an embodiment, the method 200 also includes adjusting bias current and/or output power of the light source.

The foregoing description of the illustrated embodiments of the present invention is by way of example only, and other variations and modifications of the above-described embodiments and methods are possible in light of the foregoing teaching. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. An apparatus, comprising:
a light source;
a steering device;
a lens; and
a feedback mechanism communicatively coupled to the steering device;
wherein the steering device is located between the light source and the lens,
wherein the feedback mechanism determines aberration after the light traverses the lens and adjusts the steering device to correct for aberration.

2. The apparatus of claim 1, further comprising a second light source, and wherein the steering device is located between the lens and the second light source.

3. The apparatus of claim 2, wherein one of the light sources is located at an angle to the lens.

4. The apparatus of claim 1, wherein the light source includes a laser array having a plurality of individually addressable stripes.

5. The apparatus of claim 1, wherein the light source includes a distributed Bragg reflector or a Distributed Feedback laser array with each laser stripe emitting a wavelength of a few nanometers apart to afford a wide spectral coverage.

6. The apparatus of claim 1, wherein the light source includes a laser array with each stripe emitting a laser in a different direction.

7. The apparatus of claim 6, wherein each stripe is tilted and the degree of tilt matches focusing characteristics of the lens.

8. The apparatus of claim 1, wherein the feedback mechanism further adjusts operating temperature of the light source.

9. The apparatus of claim 8, further comprising a thermal electric cooler adjacent to the light source and the feedback mechanism adjust the temperature of the light source via the thermal electric cooler.

10. The apparatus of claim 1, wherein the feedback mechanism further adjusts bias current and output power of the light source.

11. A method, comprising:
generating a light from a light source;
steering the generating light via a steering device through a lens;
determining aberration after the light traverses the lens; and
correcting for aberration in the light by adjust the steering device;
wherein the steering device is located between the light source and the lens.

12. The method of claim 11, further comprising generating light from a second light source, and wherein the steering device is located between the lens and the second light source.

13. The method of claim 12, wherein one of the light sources is located at an angle to the lens.

14. The method of claim 11, wherein the light source includes a laser array having a plurality of individually addressable stripes.

15. The method of claim 11, wherein the light source includes a distributed Bragg reflector laser array with each stripe emitting a laser with a wavelength of a few nanometers apart to afford a wide spectral coverage.

16. The method of claim 11, wherein the light source includes a laser array with each stripe emitting a laser in a different direction.

17. The method of claim 16, wherein each stripe is tilted and the degree of tilt matches focusing characteristics of the lens.

18. The method of claim 11, further comprising adjusting operating temperature of the light source.

19. The method of claim 18, wherein a thermal electric cooler is used to do the adjusting the operating temperature.

20. The method of claim 11, further comprising adjusting bias current and output power of the light source.
